(19) United States
(12) Patent Application Publication
(10) Pub. No.: US 2014/0367035 A1
(43) Pub. Date: Dec. 18, 2014

(54) OPTICAL FILTER, OPTICAL FILTER MODULE, AND ANALYZER

(71) Applicant: Seiko Epson Corporation, Tokyo (JP)

(72) Inventors: Seiji YAMAZAKI, Fujimi (JP); Akira SANO, Shiojiri (JP)

(21) Appl. No.: 14/471,366

(22) Filed: Aug. 28, 2014

Related U.S. Application Data
(62) Division of application No. 13/085,571, filed on Apr. 13, 2011.

(30) Foreign Application Priority Data
Apr. 26, 2010 (JP) 2010-101092

(51) Int. Cl. B29D 11/00; G02B 26/00

(52) U.S. Cl. CPC B29D 11/00634; G02B 26/001
USPC 156/247

(57) ABSTRACT

An etalon includes a first substrate and a second substrate. The first substrate has a first protrusion that does not face the second substrate, and a first electrode pad is formed on the first protrusion, whereby connection reliability can be improved.

### CROSS-REFERENCE TO RELATED APPLICATIONS

This is a divisional patent application of U.S. application Ser. No. 13/085,571 filed Apr. 13, 2011 which claims priority to Japanese Patent Application No. 2010-101092, filed Apr. 26, 2010 all of which are expressly incorporated by reference herein.

### BACKGROUND

1. Technical Field

The present invention relates to an optical filter that selects light of a desired target wavelength from incident light and allows the selected light to exit, an optical filter module including the optical filter, and an analyzer including the optical filter module.

2. Related Art

There has been a known optical filter including a pair of substrates and highly reflective mirrors disposed on surfaces thereof that face each other. The thus configured optical filter allows light to be reflected between the pair of mirrors and transmits only light of a specific wavelength. To transmit only light of a specific wavelength, the optical filter may only need to change the gap between the mirrors. Specifically, a movable portion is formed on one of the substrates, and one of the mirrors is formed on the movable portion and the other mirror is formed on the surface of the other substrate that faces the movable portion. An electrode is then formed on each of the substrates. In this configuration, the gap between the mirrors is changed by applying a voltage between the electrodes to produce electrostatic attraction that pulls the movable portion.

A wiring line connected to the electrode formed on each of the substrates extends outward in the radial direction of the substrate and is connected to an electrode pad provided along the outer edge of the substrate. The electrode pads, which are disposed between the pair of substrates facing each other, are electrically connected to external wiring lines connected to a conductive paste with which a small gap between each of the electrodes pad and the substrate facing the electrode pad is filled.

As another method for connecting the external wiring lines to the electrodes formed on the pair of substrates facing each other, there has been a proposed configuration in which the electrodes provided on the substrates facing each other are connected to respective extracted electrodes formed thereon and the two extraction electrodes are extracted through openings (holes) formed through one of the substrates (see JP-A-2009-134028, for example).

In the method in which the gap between each of the electrode pads and the substrate facing the electrode pad is filled with a conductive paste, however, the gap between the substrates facing each other is significantly small (ranging from 0.5 to 1 μm, for example) in the first place. It is therefore difficult in some cases to fill the gap with a conductive paste, disadvantageously resulting in decrease in connection reliability.

Further, in the method described in JP-A-2009-134028, since the extraction electrodes are provided between the pair of substrates, wiring defect could occur unless the thickness of the extraction electrodes matches that of a bonding film. For example, when the thickness of the bonding film is greater than that of the extraction electrodes, the fact that two openings are formed in one of the substrates disadvantageously causes the extraction electrode formed on that substrate to float in the openings. When external wiring lines are connected from the side where the bonding surface of the extraction electrode is present with the extraction electrode floating, the connection is unstable, resulting in decrease in connection reliability.

### SUMMARY

An advantage of some aspects of the invention is to provide an optical filter, an optical filter module, and an analyzer capable of improving connection reliability by securely extracting wiring lines connected to electrodes provided on surfaces of a pair of substrates that face each other outside the substrates.

An optical filter according to a first aspect of the invention includes a first substrate, a second substrate that faces the first substrate, a first reflection film provided on the first substrate, a second reflection film provided on the second substrate and facing the first reflection film, a first electrode provided on the first substrate, a second electrode provided on the second substrate and facing the first electrode, a first extracted wiring line provided on the first substrate and connected to the first electrode, a first electrode pad provided on the first substrate and connected to the first extracted wiring line, a second extracted wiring line provided on the second substrate and connected to the second electrode, and a second electrode pad provided on the second substrate and connected to the second extracted wiring line. At least part of the first electrode pad does not overlap with the second substrate in a plan view viewed in a thickness direction, and at least part of the second electrode pad does not overlap with the first substrate in the plan view.

In the first aspect of the invention, the first substrate and the second substrate facing each other are configured as follows. At least part of the first electrode pad provided on the first substrate does not overlap with the second substrate in the plan view. That is, the first substrate has a region that does not face the second substrate, and the first electrode pad is provided in that region. Similarly, at least part of the second electrode pad provided on the second substrate does not overlap with the first substrate in the plan view. That is, the second substrate has a region that does not face the first substrate, and the second electrode pad is provided in that region.

As described above, since the first electrode pad is not blocked by the second substrate but is exposed, for example, a connection terminal can approach the first electrode pad on the first substrate from the side where the second substrate is present in the optical filter and come into contact with the first electrode pad, whereby an external wiring line can be reliably connected to the first electrode pad. Similarly, since the second electrode pad is not blocked by the first substrate but is exposed, for example, a connection terminal can approach the second electrode pad on the second substrate from the side where the first substrate is present in the optical filter and come into contact with the second electrode pad, whereby an external wiring line can be reliably connected to the second electrode pad. The wiring connection reliability can thus be improved.

Further, at the time of manufacturing the optical filter, wiring lines can be connected to the first and second electrode pads more efficiently.

Another advantageous effect in the first aspect of the invention is as follows. As described above, an external wiring line can approach the first electrode pad provided on the first substrate from the side where the second substrate, which faces the first substrate, is present and can be connected to the first electrode pad, and an external wiring line can approach the second electrode pad provided on the second substrate from the side where the first substrate, which faces the second substrate, is present and can be connected to the second electrode pad. That is, the external wiring line connection is made with the entire first electrode pad supported by the first substrate and the entire second electrode pad supported by the second substrate. In this configuration, since no extra force acts on the first and second electrode pads at the time of connection, the first and second electrode pads will not be damaged. For example, even when a connection terminal approaches the first electrode pad from the side where the second substrate is present and is pressed against the first electrode pad, the first electrode pad will not be damaged because it is supported by the first substrate. That is, an optical filter having stable quality can be provided.

In the optical filter according to the first aspect of the invention, it is preferable that the first substrate has a first overlapping region where the first substrate overlaps with the second substrate in the plan view and a first protrusion that protrudes from the first overlapping region in an in-plane direction of the first substrate, and that the second substrate has a second overlapping region where the second substrate overlaps with the first substrate in the plan view and a second protrusion that protrudes from the second overlapping region in an in-plane direction of the second substrate. It is preferable at the same time that the first electrode pad is provided on the first protrusion, and that the second electrode pad is provided on the second protrusion.

In the first aspect of the invention, the region where the first and second substrates facing each other overlap with each other is called a first overlapping region of the first substrate and a second overlapping region of the second substrate. The first substrate has a first protrusion that protrudes from the first overlapping region along the in-plane direction, and the second substrate has a second protrusion that protrudes from the second overlapping region along the in-plane direction. In the configuration described above, the first protrusion does not face the second substrate, and the second protrusion does not face the first substrate. As a result, the first electrode pad provided on the first protrusion does not overlap with the second substrate in the plan view, and the second electrode pad provided on the second protrusion does not overlap with the first substrate in the plan view.

As described above, since the first electrode pad is not blocked by the second substrate but is exposed, for example, a connection terminal can approach the first electrode pad on the first substrate from the side where the second substrate is present in the optical filter and come into contact with the first electrode pad, whereby an external wiring line can be reliably connected to the first electrode pad. Similarly, since the second electrode pad is not blocked by the first substrate but is exposed, for example, a connection terminal can approach the second electrode pad on the second substrate from the side where the first substrate is present in the optical filter and come into contact with the second electrode pad, whereby an external wiring line can be reliably connected to the second electrode pad. The wiring connection reliability can thus be improved.

Further, at the time of manufacturing the optical filter, wiring lines can be connected to the first and second electrode pads more efficiently.

In the optical filter according to the first aspect of the invention, it is preferable that the first substrate has a first side and a second side parallel thereto, and that the second substrate has a third side and a fourth side parallel thereto, and that the direction from the first side toward the second side is the same as the direction from the third side toward the fourth side. It is preferable at the same time that the first substrate is offset relative to the second substrate in the direction from the first side toward the second side, and that the first protrusion is the portion of the first substrate that is located between the second side and the fourth side in the plan view, and that the second protrusion is the portion of the second substrate that is located between the first side and the third side in the plan view.

In the first aspect of the invention, the first substrate having a first side and a second side parallel to each other faces the second substrate having a third side and a fourth side parallel to each other. The direction from the first side toward the second side of the first substrate is the same as the direction from the third side toward the fourth side of the second substrate, and the first substrate is offset in that direction. That is, the third side, the first side, the fourth side, and the second side are so disposed in this order any adjacent pair face each other in the plan view. In the first substrate, the region from the second side to the line that coincides with the fourth side of the second substrate in the plan view is the first protrusion, which does not face the second substrate. Similarly, in the second substrate, the region from the third side to the line that coincides with the second side of the first substrate in the plan view is the second protrusion, which does not face the first substrate. In the first substrate, the first electrode pad is provided in the region described above, which includes the second side and does not face the second substrate, and in the second substrate, the second electrode pad is provided in the region described above, which includes the third side and does not face the first substrate.

In the configuration described above, an external wiring line can be more readily and reliably connected to the corresponding electrode pad provided in a peripheral portion of the corresponding substrate without being blocked by the other substrate, which faces the substrate. That is, the connection reliability can be improved.

In particular, since a space is created on the side where the connection to the first and second electrode pads is made (hereinafter also referred to as an electrode extracting space), the wiring can be readily performed and the wiring lines can be reliably connected.

An optical filter module according to a second aspect of the invention includes the optical filter described above and a light receiver that receives light under test extracted through the optical filter.

The optical filter module, for example, receives light extracted through the optical filter and outputs an electric signal representing the amount of received light.

As described above, in the optical filter, the first electrode pad provided on the first substrate does not face the second substrate, whereby an external wiring line can be reliably connected to the first electrode pad without being blocked by the second substrate. Similarly, since the second electrode pad provided on the second substrate does not face the first substrate, an external wiring line can be reliably connected to the second electrode pad without being blocked by the first substrate. That is, the wiring connection reliability can be improved. Therefore, at the time of manufacturing the optical filter, conductive lines can be connected to the first and second electrode pads more efficiently.

Therefore, the wiring connection reliability can be improved and the wiring can be performed more efficiently in the optical filter module including the optical filter as well.

An analyzer according to a third aspect of the invention includes the optical filter module described above.

Examples of the analyzer may include an optical measurement apparatus that analyzes chromaticity, brightness, and other properties of the light incident on the optical filter module described above based on an electric signal outputted therefrom, a gas detector that detects the wavelength of light absorbed by a gas to identify the type of the gas, and an optical communication apparatus that receives light of a specific wavelength and acquires data contained in the received light.

In the third aspect of the invention, since the optical filter module allows the wiring connection reliability to be improved as described above, the analyzer including the optical filter module also allows the connection reliability to be improved, whereby stable quality can be provided.

### BRIEF DESCRIPTION OF THE DRAWINGS

The invention will now be described with reference to the accompanying drawings, wherein like numbers refer to like elements.

FIG. 1 shows a schematic configuration of an analyzer of a first embodiment according to the invention.

FIG. 2 is a plan view showing a schematic configuration of an etalon that forms an optical filter according to the first embodiment.

FIG. 3 is a perspective view showing a schematic configuration of the etalon according to the first embodiment.

FIG. 4 is a cross-sectional view showing a schematic configuration of the etalon according to the first embodiment.

FIGS. 5A to 5D are cross-sectional views showing steps of manufacturing a first substrate that forms the etalon according to the embodiment.

FIGS. 6A to 6D are cross-sectional views showing other steps of manufacturing the first substrate in the embodiment.

FIGS. 7A to 7D are cross-sectional views showing steps of manufacturing a second substrate that forms the etalon according to the embodiment.

FIGS. 8A to 8D are cross-sectional views showing other steps of manufacturing the second substrate in the embodiment.

FIGS. 9A and 9B are cross-sectional views showing steps of manufacturing the etalon according to the embodiment.

### DESCRIPTION OF EXEMPLARY EMBODIMENTS

An analyzer according to a first embodiment of the invention will be described below with reference to the drawings.

### 1. Overall Configuration of Analyzer

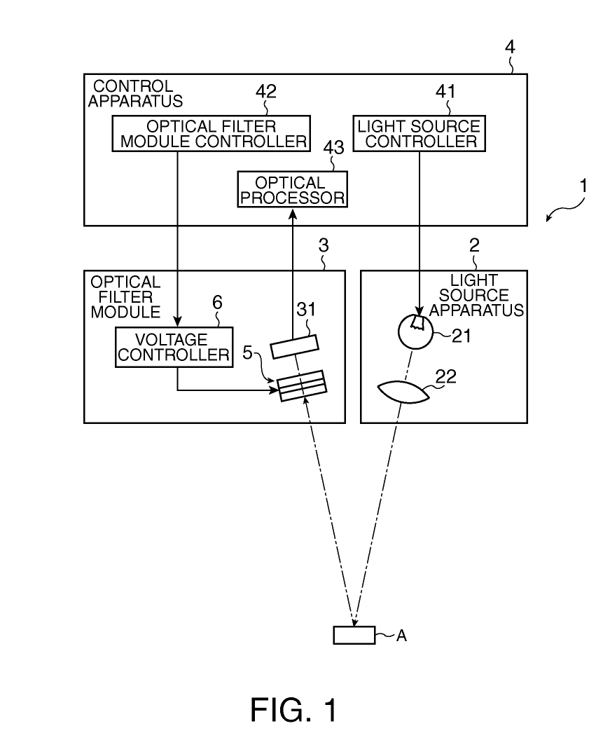

An analyzer 1 includes a light source apparatus 2 that emits light toward an object under test A, an optical filter module 3 according to an embodiment of the invention, and a control apparatus 4 that controls the overall action of the analyzer 1, as shown in FIG. 1. In the operation of the analyzer 1, the object under test A reflects the light emitted from the light source apparatus 2, and the optical filter module 3 receives the reflected light under test. The analyzer 1 analyzes and measures the chromaticity of the light under test, that is, the color of the object under test A, based on a detection signal outputted from the optical filter module 3.

### 2. Configuration of Light Source Apparatus

The light source apparatus 2 includes a light source 21 and a plurality of lenses 22 (FIG. 1 shows only one lens) and emits white light toward the object under test A. The plurality of lenses 22 includes a collimator lens, which parallelizes the white light emitted from the light source 21, and the light source apparatus 2 directs the parallelized light toward the object under test A through a projection lens (not shown).

### 3. Configuration of Optical Filter Module

The optical filter module 3 includes an etalon 5 that forms an optical filter according to an embodiment of the invention, a light receiving device 31 as a light receiver that receives the light having passed through the etalon 5, and a voltage controller 6 that changes the wavelength of the light that the etalon 5 transmits. The optical filter module 3 further includes a light incident-side optical lens (not shown) that faces the etalon 5 and guides the light reflected off the object under test A (light under test) into the optical filter module 3. In the optical filter module 3, the etalon 5 separates light of a predetermined wavelength from the light under test having been incident through the light incident-side optical lens, and the light receiving device 31 receives the separated light.

The light receiving device 31, which is formed of a plurality of photoelectric conversion devices, produces an electric signal according to the amount of received light. The light receiving device 31, which is connected to the control apparatus 4, outputs the produced electric signal as a received light signal to the control apparatus 4.

### 3-1. Configuration of Etalon

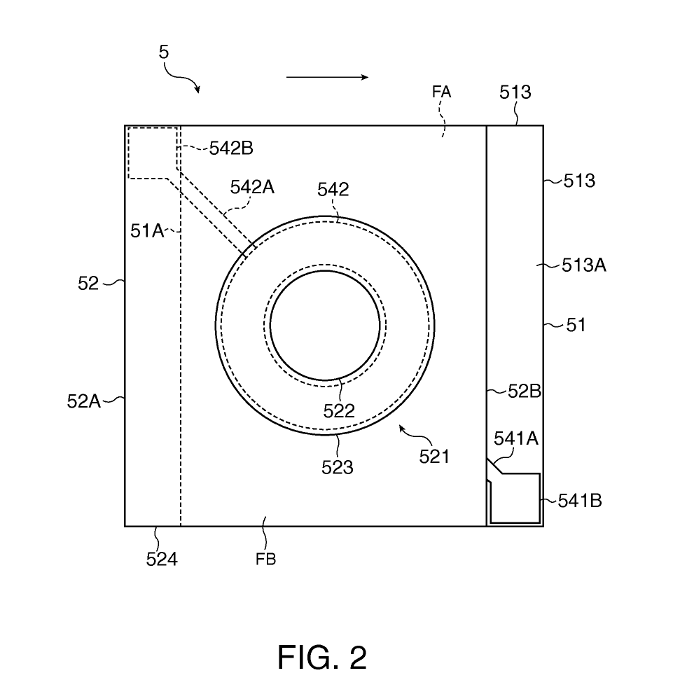

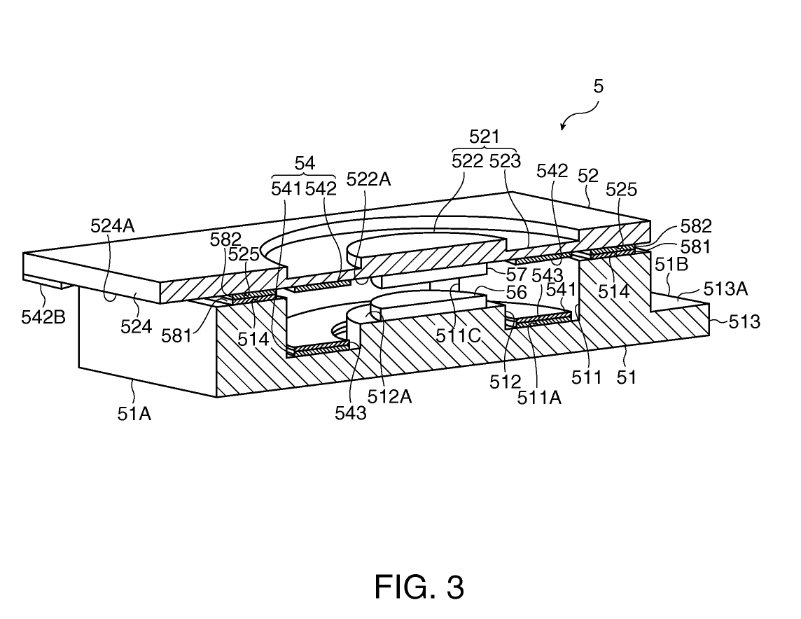

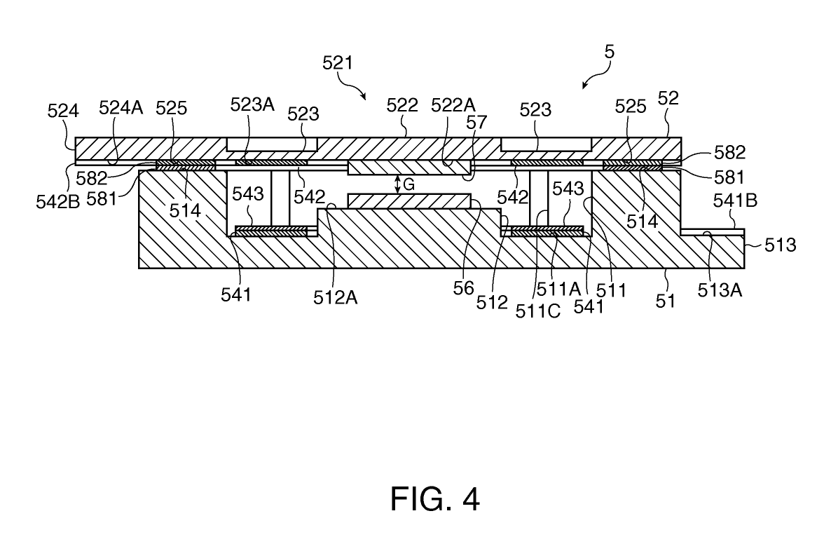

The configuration of the etalon 5 will be described below with reference to FIGS. 2 to 4. It is noted that the light under test is incident upward on the etalon 5 in FIG. 1, whereas the light under test is incident downward on the etalon 5 in FIGS. 3 and 4.

The etalon 5 is a plate-shaped optical member having a square shape in a plan view, as shown in FIG. 2, and each side of the etalon 5 is, for example, 10 mm long. The etalon 5 includes a first substrate 51 and a second substrate 52. Each of the two substrates 51 and 52 is made of soda glass, crystalline glass, quartz glass, lead glass, potassium glass, borosilicate glass, no-alkali glass, or a variety of any other suitable glass materials, or crystal.

The first substrate 51 and the second substrate 52 are integrated with each other by bonding a bonding surface 514 to a bonding surface 525, which will be described later. In a plan view of the etalon 5 shown in FIG. 2, which is viewed in the thickness direction thereof (hereinafter referred to as an etalon plan view), the region where the first substrate 51 overlaps with the second substrate 52, that is, the region of the first substrate 51 that is sandwiched between a first side 51A of the first substrate 51 and a fourth side 52B of the second substrate is called a first overlapping region FA, and the region where the second substrate 52 overlaps with the first substrate 51, that is, the region of the second substrate 52 that is sandwiched between the first side 51A of the first substrate 51 and the fourth side 52B of the second substrate is called a second overlapping region FB.

A fixed mirror 56 and a movable mirror 57 are provided between the first substrate 51 and the second substrate 52, as shown in FIGS. 3 and 4. The fixed mirror 56 is fixed onto the surface of the first substrate 51 that faces the second substrate 52, and the movable mirror 57 is fixed onto the surface of the second substrate 52 that faces the first substrate 51. The fixed mirror 56 and the movable mirror 57 are so disposed that they face each other with an inter-mirror gap G therebetween.

An electrostatic actuator 54 for adjusting the dimension of the inter-mirror gap G between the fixed mirror 56 and the movable mirror 57 is further provided between the first substrate 51 and the second substrate 52.

### 3-1-1. Configuration of First Substrate

The first substrate 51 has a substantially square shape, in the etalon plan view, having the first side 51A and a second side 51B on opposite sides and the other two sides perpendicular thereto and parallel to each other. The fixed substrate 51 is formed by etching a glass base having a thickness of 500 μm or any other suitable value. Specifically, the first substrate 51 has an electrode formation groove 511, a mirror fixing portion 512, and a first protrusion 513 formed in an etching process, as shown in FIGS. 3 and 4.

The electrode formation groove 511 has a circular shape around the center of the etalon in the etalon plan view. The mirror fixing portion 512 protrudes from a central portion of the electrode formation groove 511 in the plan view described above toward the second substrate 52.

The electrode formation groove 511 has a ring-shaped electrode fixing surface 511A formed between the outer circumferential edge of the mirror fixing portion 512 and the inner circumferential wall of the electrode formation groove 511, and a first electrode 541 is formed on the electrode fixing surface 511A. The first electrode 541 is not particularly limited to a specific one but can be made of any conductive material that allows electrostatic attraction to be produced between the first electrode 541 and a second electrode 542 on the second substrate 52, which will be described later, when a voltage is applied between the first electrode and the second electrode 542. In the present embodiment, the first electrode 541 is formed of an ITO film.

An insulating film 543 is formed on the first electrode 541. The insulating film 543 is made of TEOS (tetraethoxysilane).

The mirror fixing portion 512 has a cylindrical shape that is coaxial with the electrode formation groove 511, as described above, and has a diameter smaller than that of the electrode formation groove 511. In the present embodiment, a mirror fixing surface 512A of the mirror fixing portion 512 faces the second substrate 52 and is closer thereto than the electrode fixing surface 511A is, as shown in FIG. 4, but the configuration described above is not necessarily employed, because the positions of the electrode fixing surface 511A and the mirror fixing surface 512A in the height direction are determined as appropriate in accordance with the dimension of the inter-mirror gap G between the fixed film 56 fixed onto the mirror fixing surface 512A and the movable mirror 57 formed on the second substrate 52, the dimension between the first electrode 541 and the second electrode 542 formed on the second substrate 52, which will be described later, and the thicknesses of the fixed mirror 56 and the movable mirror 57. For example, when each of the mirrors 56 and 57 is formed of a dielectric multilayer film mirror having a larger thickness, the electrode fixing surface 511A and the mirror fixing surface 512A may be flush with each other, or a mirror fixing groove having a cylindrically recessed shape may be formed in a central portion of the electrode fixing surface 511A and the mirror fixing surface 512A may be formed at the bottom of the mirror fixing groove.

The depth of the groove with respect to the mirror fixing surface 512A of the mirror fixing portion 512 is preferably designed also in consideration of the wavelength band that the etalon 5 transmits. For example, in the present embodiment, an initial value of the inter-mirror gap G between the fixed mirror 56 and the movable mirror 57 (the dimension of the inter-mirror gap G when no voltage is applied between the first electrode 541 and the second electrode 542) is set at 450 nm, and the movable mirror 57 can be displaced to the point where the inter-mirror gap G decreases, for example, to 250 nm by applying a voltage between the first electrode 541 and the second electrode 542. In this configuration, changing the voltage between the first electrode 541 and the second electrode 542 allows light of a desired wavelength to be selectively separated from the entire visible wavelength range and the selected light to be transmitted. In this case, the film thicknesses of the fixed mirror 56 and the movable mirror 57 and the height dimensions of the mirror fixing surface 512A and the electrode fixing surface 511A may be set at values that allow the inter-mirror gap G to be changed between 250 and 450 nm.

The fixed mirror 56 having a circular shape and a diameter of approximately 3 mm is fixed onto the mirror fixing surface 512A. The fixed mirror 56 is formed of an Ag-alloy monolayer and formed on the mirror fixing surface 512A, for example, in a sputtering process.

The present embodiment will be described with reference to a case where the fixed mirror 56 is formed of an Ag-alloy monolayer that can be used in the etalon 5 to separate light of a desired wavelength from the entire visible wavelength range. The fixed mirror 56 is not necessarily formed of an Ag-alloy monolayer but may be formed, for example, of a TiO₂—SiO₂-based dielectric multilayer film mirror. In this case, the wavelength band from which the etalon 5 can separate a desired wavelength is narrower, but the transmittance for the separated light is higher than that of an AgC monolayer mirror. In addition, the width at half maximum of the transmittance is narrow and hence the resolution is excellent. In the case of the TiO₂—SiO₂-based dielectric multilayer film mirror as well, the positions of the mirror fixing surface 512A and the electrode fixing surface 511A of the first substrate 51 in the height direction need to be determined as appropriate in accordance with the fixed mirror 56, the movable mirror 57, the wavelength selection band of the light to be separated, and other factors, as described above.

The first protrusion 513 is so formed that it protrudes from the first overlapping region FA of the first substrate 51 in the plane direction thereof and includes the second side 51B of the first substrate 51 and two adjacent corners of the first substrate 51. The first protrusion 513 further has a first pad fixing surface 513A flush with the electrode fixing surface 511A. When the first substrate 51 overlaps with the second substrate 52, a space is created on the side where the second substrate 52 is present above the first pad fixing surface 513A because the first protrusion 513 does not face the second substrate 52.

A first electrode pad 541B is formed in the vicinity of one of the corners of the first substrate 51 on the first pad fixing surface 513A. The entire first electrode pad 541B may be exposed to the space above the first pad fixing surface 513A or part of the first electrode pad 541B may be exposed to the space above the first pad fixing surface 513A.

A first electrode introducing groove 511C is formed in the first substrate 51 from the vicinity of one of the corners of the first substrate 51 on the first pad fixing surface 513A to the electrode fixing surface 511A. The first electrode introducing groove 511C has a bottom surface flush with the electrode fixing surface 511A and the first pad fixing surface 513A.

A first electrode extracting portion 541A is formed on the bottom surface of the first electrode introducing groove 511C. The first electrode extracting portion 541A extends from part of the outer circumferential edge of the first electrode 541 and is connected to the first electrode pad 541B. In this way, the first electrode 541, the first electrode extracting portion 541A, and the first electrode pad 541B are electrically connected to each other, and a predetermined voltage can be applied to the first electrode 541. The first electrode 541, the first electrode extracting portion 541A, and the first electrode pad 541B are integrally formed of an ITO film in the form of an integrated electrode deposited on the first substrate 51 in a sputtering or any other suitable process.

The portion of the first substrate 51 that has no groove or the first protrusion 513 forms the bonding surface 514 of the first substrate 51. The bonding surface 514 is the region surrounded by the side of the first protrusion 513 that faces away from the second side 51B, either one of the other two sides perpendicular to the first side 51A and the second side 51B in a plan view, and the electrode fixing surface 511A.

A first bonding film 581, which is provided for a bonding purpose, is formed on the bonding surface 514, as shown in FIGS. 3 and 4. The first bonding film 581 is primarily made of polyorganosiloxane.

The first substrate 51 further has an anti-reflection (AR) film (not shown) formed on the lower surface, which faces away from the upper surface facing the second substrate 52, in the position corresponding to the fixed mirror 56. The anti-reflection film is formed by alternately stacking a low refractive index film and a high refractive index film. The anti-reflection film reduces the reflectance of the surface of the first substrate 51 for visible light but increases the transmittance of the surface of the first substrate 51 for visible light.

### 3-1-2. Configuration of Second Substrate

The second substrate 52 is so formed that it has a rectangular plan shape formed of a third side 52A and the fourth side 52B facing away from each other and the other two sides perpendicular thereto and parallel to each other. The size of each of the first substrate 51 and the second substrate 52 is so adjusted that the etalon 5 obtained by bonding the substrates to each other has a substantially square shape in a plan view. The second substrate 52 is formed by etching a glass base having a thickness of 200 μm or any other suitable value.

Specifically, the second substrate 52 has a circular displacement portion 521 formed around the center of the etalon in the etalon plan view, as shown in FIG. 2. The displacement portion 521 includes a cylindrical movable portion 522 and a connecting/holding portion 523 that is coaxial with the movable portion 522 and holds the movable portion 522.

The displacement portion 521 described above is formed by etching a flat plate-shaped glass base from which the second substrate 52 is formed to form a groove, as shown in FIGS. 3 and 4. That is, the displacement portion 521 is formed by etching the light incident-side surface of the second substrate 52 that does not face the first substrate 51 to form an annular recessed groove for forming the connecting/holding portion 523.

The movable portion 522 is so formed that it is thicker than the connecting/holding portion 523. In the present embodiment, for example, the movable portion 522 has a thickness of 200 μm, which is equal to the thickness of the second substrate 52. The movable portion 522 has a movable surface 522A parallel to the mirror fixing portion 512, and the movable mirror 57 is fixed onto the movable surface 522A.

The movable mirror 57 has the same configuration as that of the fixed mirror 56 described above and is formed of an Ag-alloy monolayer mirror in the present embodiment. The film thickness of the Ag-alloy monolayer mirror is, for example, 0.03 μm.

The movable portion 522 has an anti-reflection (AR) film (not shown) formed on the upper surface, which faces away from the movable surface 522A, in the position corresponding to the movable mirror 57. The anti-reflection film has the same configuration as that of the anti-reflection film formed on the first substrate 51 and is formed by alternately stacking a low refractive index film and a high refractive index film.

The connecting/holding portion 523 is a diaphragm surrounding the movable portion 522 and has a thickness of 50 μm or any other suitable value. The second electrode 542 having a ring shape is formed on a second electrode fixing surface 523A of the connecting/holding portion 523, which faces the first substrate 51. The second electrode 542 thus faces the first electrode 541 with an electromagnetic gap of approximately 1 μm therebetween. The second electrode 542 and the first electrode 541, which has been described above, form the electrostatic actuator 54. The second electrode 542 is formed of an ITO film as in the case of the electrode and the bonding film formed on the first electrode 541.

The second substrate 52 includes a second protrusion 524 so formed that it protrudes in the plane direction from the second overlapping region FB of the second substrate 52 and that it includes the third side 52A and two adjacent corners of the second substrate 52. The second protrusion 524 has a second pad fixing surface 524A flush with the second electrode fixing surface 523A. When the first substrate 51 overlaps with the second substrate 52, an electrode extracting space is created on the side where the first substrate 51 is present above the second pad fixing surface 524A because the second protrusion 524 does not face the first substrate 51.

A second electrode pad 542B is formed in the vicinity of one of the corners of the second substrate 52 on the second pad fixing surface 524A.

A second electrode extracting portion 542A is so formed that it extends from part of the outer circumferential edge of the second electrode 542 and is connected to the second electrode pad 542B. In this way, the second electrode 542, the second electrode extracting portion 542A, and the second electrode pad 542B are electrically connected to each other, and a predetermined voltage can be applied to the second electrode 542. The second electrode 542, the second electrode extracting portion 542A, and the second electrode pad 542B are integrally formed of an ITO film in the form of an integrated electrode deposited on the second substrate 52 in a sputtering or any other suitable process.

The portion of the surface of the second substrate 52 that faces the first substrate 51, the region that faces the bonding surface 514 of the first substrate 51, forms the bonding surface 525 of second substrate 52. A second bonding film 582 primarily made of polyorganosiloxane is provided on the bonding surface 525, as in the case of the bonding surface 514 of the first substrate 51.

3-1-3. Configuration in which First Substrate and Second Substrate are Bonded to Each Other

The etalon 5 is formed by bonding the bonding surface 514 of the first substrate 51 to the bonding surface 525 of the second substrate 52 described above into an integrated structure. The thus formed etalon 5 has the first overlapping region FA and the second overlapping region FB bonded to each other and the first protrusion 513 and the second protrusion 524 protruding in the plane direction from the respective overlapping regions. In other words, the configuration described above has an initial state in which the first side 51A of the first substrate 51 and the third side 52A of the second substrate 52 coincide with each other in a plan view and the second side 51B of the first substrate 51 and the fourth side 52B of the second substrate 52 coincide with each other in a plan view, and then transitions to a configuration in which the first substrate 51 is offset relative to the second substrate 52 in the direction from the first side 51A toward the second side 52B (the direction indicated by the arrow in FIG. 2).

Therefore, as shown in FIG. 2, the portion of the first substrate 51 that is surrounded by the fourth side 52B of the second substrate 52 and the second side 51B of the first substrate 51 forms the first protrusion 513 described above, and part of the region surrounded by the fourth side 52B of the second substrate 52 and the first side 51A of the first substrate 51, that is, the portion where no groove is formed, forms the first bonding surface 514. Similarly, the portion of the second substrate 52 that is surrounded by the first side 51A of the first substrate 51 and the third side 52A of the second substrate 52 forms the second protrusion 524 described above, and part of the region surrounded by the first side 51A of the first substrate 51 and the fourth side 52B of the second substrate 52, that is, the portion that faces the first bonding surface 514 of the first substrate 51, forms the second bonding surface 525.

The first electrode 541 is electrically connected to the first electrode pad 541B via the first electrode extracting portion 541A. Similarly, the second electrode 542 is electrically connected to the second electrode pad 542B via the second electrode extracting portion 542A.

The electrostatic actuator 54 can therefore be controlled by connecting conductive wires connected to the voltage controller 6 to the first electrode pad 541B and the second electrode pad 542B, respectively.

In the present embodiment, one first electrode pad 541B and one second electrode pad 542B are provided. Alternatively, two first electrode pads 541B and two second electrode pads 542B may be provided. In this case, to drive the electrostatic actuator 54, a voltage is applied to only one of the two first electrode pads 541B and only one of the two second electrode pads 542B. The other first electrode pad 541B and second electrode pad 542B are used as detection terminals for detecting the amount of charge held by the first electrode 541 and the second electrode 542.

### 3-1-4. Connecting Etalon to Voltage Controller

To connect the etalon 5 described above to the voltage controller 6, the conductive wires connected to the voltage controller 6 are connected to the first electrode pad 541B and the second electrode pad 542B, for example, via a flexible substrate.

In the etalon 5, the first protrusion 513 of the first substrate 51 does not face the second substrate 52, and the second protrusion 524 of the second substrate 52 does not face the first substrate 51. In this configuration, to connect the conductive wires to the etalon 5, the flexible substrate may only be placed on and connected to the first electrode pad 541B formed on the first pad fixing surface 513A of the first protrusion 513 and the second electrode pad 542B formed on the second pad fixing surface 524A of the second protrusion 524. That is, filling the space between the substrates facing each other with a conductive paste or other cumbersome work is unnecessary, but direct connection to the first electrode pad 541B and the second electrode pad 542B can be achieved. Further, since the first protrusion 513 and the second protrusion 524 face no substrate, a large working space can be created, whereby wiring lines can be readily connected to the etalon 5.

### 3-2. Configuration of Voltage Controller

The voltage controller 6 along with the etalon 5 described above forms an optical filter according to an embodiment of the invention. The voltage controller 6 controls the voltage applied to the first electrode 541 and the second electrode 542 of the electrostatic actuator 54 based on a control signal inputted from the control apparatus 4.

### 4. Configuration of Control Apparatus

The control apparatus 4 controls the overall action of the analyzer 1.

The control apparatus 4 can, for example, be a general-purpose personal computer, a personal digital assistant, or a computer dedicated to colorimetry.

The control apparatus 4 includes a light source controller 41, an optical filter module controller 42, and an optical processor 43, as shown in FIG. 1.

The light source controller 41 is connected to the light source apparatus 2. The light source controller 41 outputs a predetermined control signal to the light source apparatus 2 based, for example, on an input set by a user and instructs the light source apparatus 2 to emit white light of predetermined brightness.

The optical filter module controller 42 is connected to the optical filter module 3. The optical filter module controller 42 sets the wavelength of light to be received by the optical filter module 3 based, for example, on an input set by the user and outputs a control signal to the optical filter module 3 to instruct it to detect the amount of received light of the wavelength. The voltage controller 6 in the optical filter module 3 then sets the voltage to be applied to the electrostatic actuator 54 based on the control signal so that only the light of the wavelength desired by the user is transmitted.

### Method for Manufacturing Etalon

A method for manufacturing the etalon 5 described above will next be described with reference to the drawings.

To manufacture the etalon 5, the first substrate 51 and the second substrate 52 are formed, and the formed first substrate 51 and second substrate 52 are bonded to each other.

### 5-1. First Substrate Formation Step

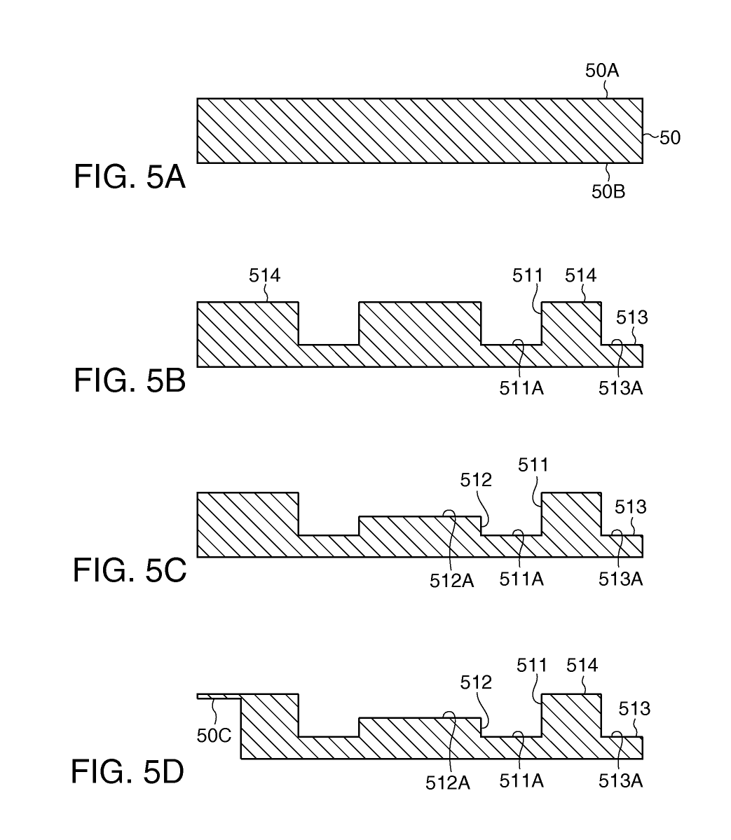

A quartz glass substrate 50 shown in FIG. 5A (having a surface roughness Ra of 1 nm or smaller and a thickness of 500 μm) from which the first substrate 51 is manufactured undergoes a polishing process in which both surfaces of the quartz glass substrate 50 form mirrors, and a resist (not shown) is applied onto each of the surfaces of the quartz glass substrate 50.

First, the electrode formation groove 511 and the first protrusion 513 are formed to a depth of 1 μm, as shown in FIG. 5B, by etching part of a surface 50A that faces the second substrate 52, the portion other than the bonding surface 514 and the mirror fixing portion 512, by using a hydrofluoric acid aqueous solution. The electrode fixing surface 511A of the electrode formation groove 511 is flush with the first pad fixing surface 513A of the first protrusion 513. The resist left on the surface facing the second substrate 52 is then stripped off.

Thereafter, a resist (not shown) is applied onto the surface 50A again, which faces the second substrate 52, and patterned to the shape of the mirror fixing portion 512, and etching using a hydrofluoric acid aqueous solution is carried out. As a result, the mirror fixing portion 512 having the mirror fixing surface 512A is formed at a level higher than the electrode fixing surface 511A, as shown in FIG. 5C. The resist left on the surface 50A, which faces the second substrate 52, is then stripped off.

A resist (not shown) is applied onto a surface 50B that faces away from the side facing the second substrate 52 and patterned to the shape for forming an electrode extracting space, and etching using a hydrofluoric acid aqueous solution is carried out to a depth of approximately 450 nm. As a result, a first thin piece 50C is formed, as shown in FIG. 5D. The first thin piece 50C, which will face the second pad fixing surface 524A of the second protrusion 524 of the second substrate 52, is temporarily provided to prevent sputtering, resist application, and other processes from affecting the second pad fixing surface 524A in any of the etalon manufacturing steps. The first thin piece 50C is therefore removed after the first substrate 51 is bonded to the second substrate 52. The resist left on the surface 50B, which faces away from the side facing the second substrate 52, is then stripped off.

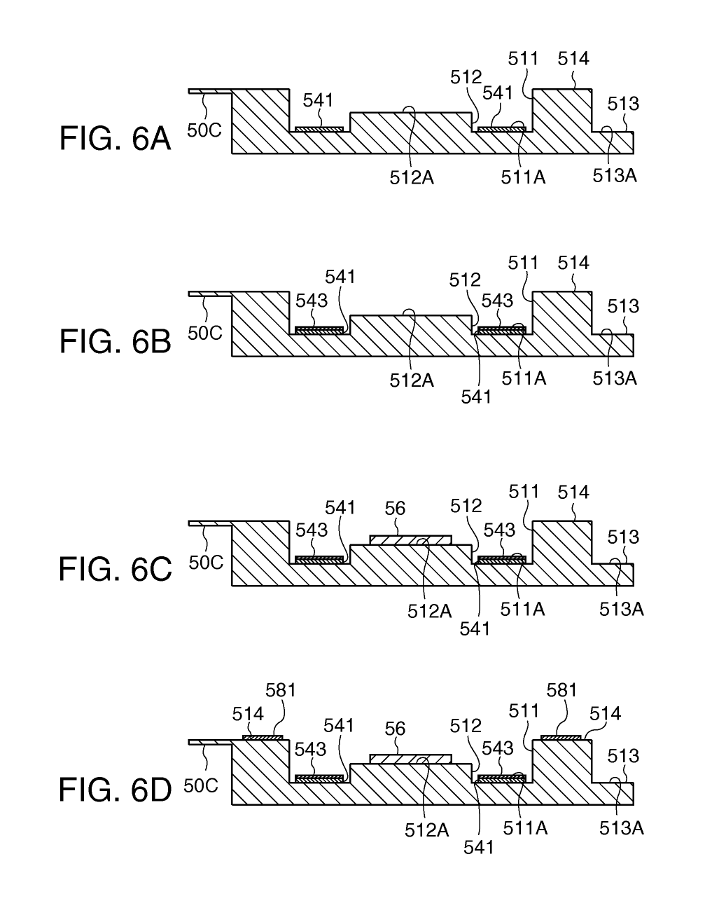

An ITO film (having a thickness of 0.1 μm) (not shown) for electrode formation is then deposited in a sputtering process on the surface 50A of the quartz glass substrate 50, which faces the second substrate 52. A resist is applied onto the ITO film and patterned to a desired electrode shape, and the ITO film with the resist is etched by a mixed solution of nitric acid and hydrochloric acid. As a result, the first electrode 541 is formed, as shown in FIG. 6A. The resist left on the surface 50A, which faces the second substrate 52, is then stripped off.

A resist (not shown) is applied onto the surface 50A again, which faces the second substrate 52, and patterned to expose only the first electrode 541, and a TEOS (tetraethoxysilane) having a thickness of 0.1 μm is deposited in a plasma CVD process. The insulating film 543 is thus formed on the first electrode 541 by stripping the resist off, as shown in FIG. 6B.

Thereafter, a resist (not shown) is applied onto the surface 50A again, which faces the second substrate 52, and patterned to expose only the region of the mirror fixing surface 512A where the fixed mirror 56 is formed, and a mirror material is deposited in a sputtering or deposition process. For example, a SiO₂ layer 50 nm thick, a TiO₂ layer 50 nm thick, and a Ag layer 50 nm thick are stacked in this order on the mirror fixing surface 512A. The fixed mirror 56 is thus formed on the mirror fixing surface 512A by stripping the resist off, as shown in FIG. 6C.

A resist (not shown) is applied onto the surface 50A again, which faces the second substrate 52, and patterned to expose only the region where the first bonding film 581 is formed, and a plasma polymerization film having a thickness of 30 nm is deposited in a plasma CVD process. The plasma polymerization film is preferably primarily made of polyorganosiloxane. The first bonding film 581 is thus formed on the bonding surface 514 by stripping the resist off, as shown in FIG. 6D.

The first substrate 51 with the first thin piece 50C is thus completed.

### 5-2. Second Substrate Manufacturing Step

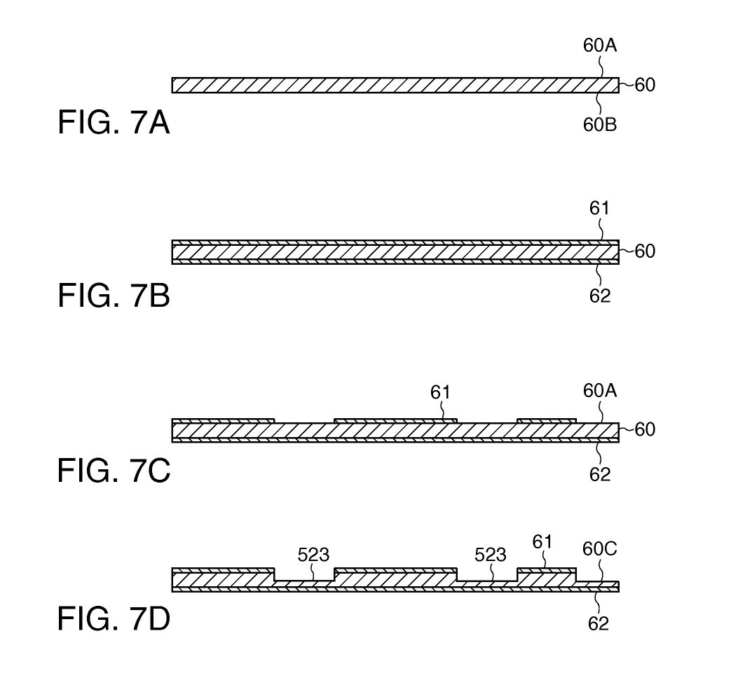

A quartz glass substrate (having a surface roughness Ra of 1 nm or smaller) from which the second substrate 52 is manufactured undergoes a polishing process in which both surfaces of the quartz glass substrate form mirrors. A quartz glass substrate 60 having a thickness of 200 μm is thus formed, as shown in FIG. 7A.

Thereafter, Cr/Au films 61 and 62 are deposited on both surfaces 60A and 60B of the quartz glass substrate 60 in a sputtering process, as shown in FIG. 7B. The thickness of the Cr film is 50 nm, and the thickness of the Au film is 500 nm.

A pattern for forming the connecting/holding portion 523 (diaphragm) and a space for extracting the electrode on the first substrate 51 is formed on the Cr/Au film on the surface 60A where the diaphragm is formed, and the portion of the Cr/Au film that corresponds to the diaphragm and the space is removed, as shown in FIG. 7C. In this process, the Au film is etched by a mixed solution of iodine and potassium iodide, and the Cr film is etched by a ceric ammonium nitrate aqueous solution.

The quartz glass substrate 60 is then etched by immersing it in a hydrofluoric acid aqueous solution to a depth of 150 μm. As a result, the connecting/holding portion 523 and a second thin piece 60C, each of which has a thickness of 50 μm, are formed, as shown in FIG. 7D.

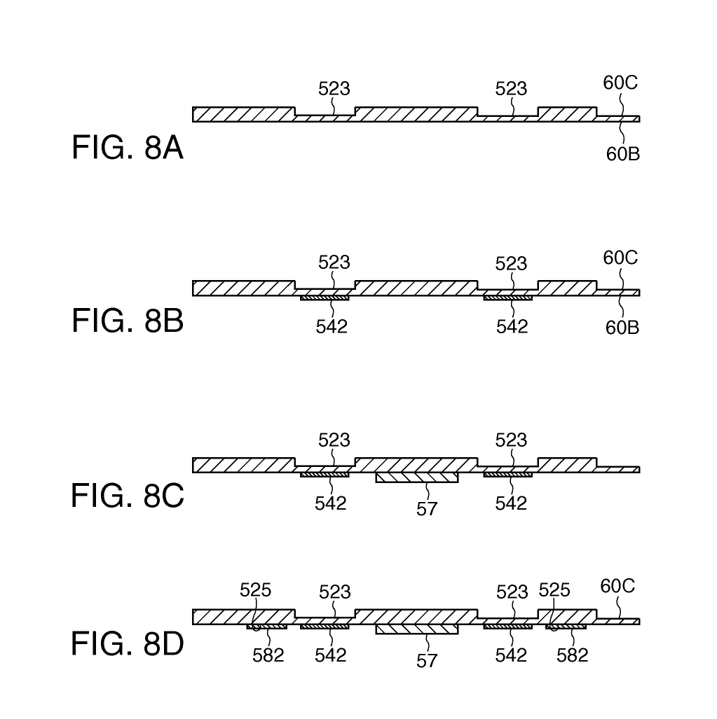

The Cr/Au films 61 and 62 left on both surfaces of the quartz glass substrate 60 are stripped off, as shown in FIG. 8A.

An ITO film (having a thickness of 0.1 μm) (not shown) for electrode formation is then deposited in a sputtering process on the surface 60B, which undergoes an electrode formation process. A resist is applied onto the ITO film and patterned to a desired electrode shape, and the ITO film with the resist is etched by a mixed solution of nitric acid and hydrochloric acid. As a result, the second electrode 542 is formed, as shown in FIG. 8B. The resist left on the surface 60B, where the electrode has been formed, is stripped off.

A resist (not shown) is then applied onto the surface 60B again, where the electrode has been formed, and patterned to expose only the region where the movable mirror 57 is formed, and a mirror material is deposited in a sputtering or deposition process. For example, a SiO₂ layer 50 nm thick, a TiO₂ layer 50 nm thick, and a Ag layer 50 nm thick are stacked in this order on the substrate. The movable mirror 57 is thus formed on the surface 60B, where the electrode has been formed, by stripping the resist off, as shown in FIG. 8C.

A resist (not shown) is then applied onto the surface 60B again, where the electrode has been formed, and patterned to expose only the region where the second bonding film 582 is formed, and a plasma polymerization film having a thickness of nm is deposited in a plasma CVD process. The plasma polymerization film is preferably primarily made of polyorganosiloxane. The second bonding film 582 is thus formed on the bonding surface 525 by stripping the resist off, as shown in FIG. 8D.

The second substrate 52 with the second thin piece 60C is thus completed.

### 5-3. Bonding Step

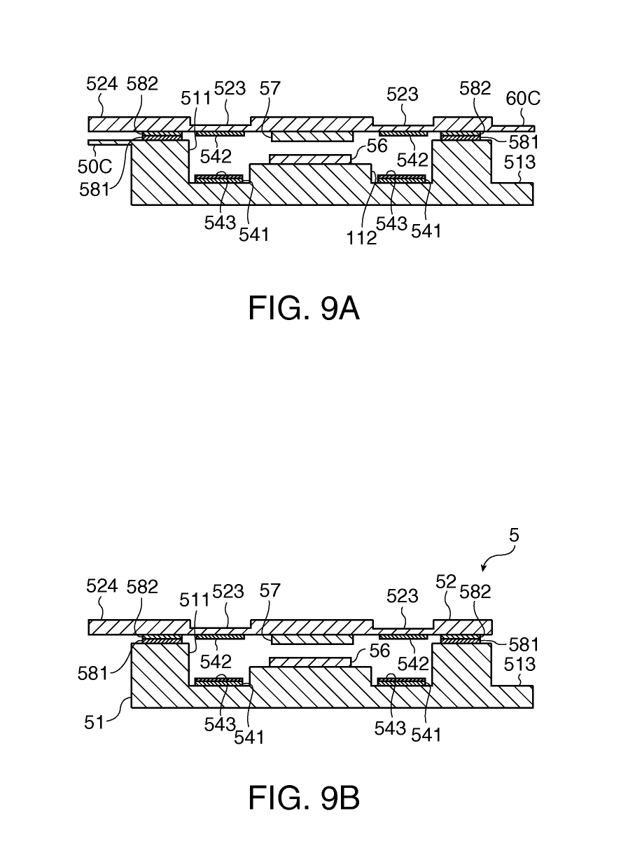

The substrates formed in the first and second substrate formation steps are then bonded to each other, as shown in FIG. 9A. Specifically, an O₂ plasma process or a UV process is carried out in order to give activation energy to the plasma polymerization films, which forms the first bonding film 581 and the second bonding film 582 formed on the respective substrates. The O₂ plasma process is carried out for 30 seconds under the conditions of an O₂ flow rate of 30 cc/min, a pressure of 27 Pa, and an RF power of 200 W. Alternatively, the UV process is carried out for 3 minutes by using an eximer UV laser (having a wavelength of 172 nm) as a UV light source. After activation energy is given to the plasma polymerization films, the two substrates are aligned with each other, and a load is applied to the substrates with the first bonding film 581 and the second bonding film 582 facing each other. The substrates are thus bonded to each other.

The first thin piece 50C extending from the first substrate 51 and the second thin piece 60C extending from the second substrate 52 are then removed. The removal may be carried out in a mechanical process, such as cutting, or in a chemical process, such as etching. The etalon 5 is thus manufactured.

### 6. Advantageous Effects of Present Embodiment

The embodiment described above can provide the following advantageous effects.

The first electrode pad 541B of the first substrate 51 is provided on the first protrusion 513, which does not face the second substrate 52. The first electrode pad 541B therefore does not overlap with the second substrate 52 in the etalon plan view. That is, the first electrode pad 541B is exposed, and an electrode extracting space is created on the side where the second substrate 52 is present above the first electrode pad 541B. The configuration described above, in which the first electrode pad 541B is not blocked by the second substrate 52 but is exposed, allows a flexible substrate that serves as an external wiring line to be readily connected to the first electrode pad 541B.

Similarly, the second electrode pad 542B of the second substrate 52 is provided on the second protrusion 524, which does not face the first substrate 51. The second electrode pad 542B therefore does not overlap with the first substrate 51 in the etalon plan view. That is, the second electrode pad 542B is exposed, and an electrode extracting space is created on the side where the first substrate 51 is present above the second electrode pad 542B. The configuration described above, in which the second electrode pad 542B is not blocked by the first substrate 51 but is exposed, allows a flexible substrate that serves as an external wiring line to be readily connected to the second electrode pad 542B.

Therefore, the connection can be securely made, and connection reliability can be improved.

In particular, since the first protrusion 513 is formed along the edge (second side 51B) of the first substrate 51, a wiring line can be readily connected to the first electrode pad 541B provided on the first protrusion 513. Similarly, since the second protrusion 524 is formed along the edge (third side 52A) of the second substrate 52, a wiring line can be readily connected to the second electrode pad 542B provided on the second protrusion 524.

As described above, since wiring connection can be readily made without being blocked by the substrate present on the side where the wiring connection is made, a wiring line can be securely connected and connection reliability is further improved.

In the step of manufacturing the first substrate 51, the first thin piece 50C is formed in the position that faced the second protrusion 524 when the second substrate 52 is bonded to the first substrate 51. Similarly, in the step of manufacturing the second substrate 52, the second thin piece 60C is formed in the position that faces the first protrusion 513 when the first substrate 51 is bonded to the second substrate 52. After the first substrate 51 and the second substrate 52 are bonded to each other, the first thin piece 50C and the second thin piece 60C are removed.

Since the first electrode pad 541B provided on the first protrusion 513 and the second electrode pad 542B provided on the second protrusion 524 are exposed in the thus configured etalon 5, resist patterning can be disadvantageously complicated and hence workability can be degraded. Covering the exposed first electrode pad 541B and second electrode pad 542B with the first thin piece 50C and the second thin piece 60C respectively until the etalon 5 is completed eliminates the need to consider the exposed portions, whereby each process can be readily carried out with satisfactory workability.

### 7. Variations

The invention is not limited to the embodiment described above. Changes, improvements, and other modifications can be made to the extent that they can still achieve the advantage of the invention, and these variations fall within the scope of the invention.

For example, in the embodiment described above, each of the first electrode 541, the first electrode extracting portion 541A, the first electrode pad 541B, the second electrode 542, the second electrode extracting portion 542A, and the second electrode pad 542B is formed of an ITO film. Alternatively, they may be made of a Au/Cr alloy, a Au/Sn alloy, or any other suitable material.

Further, the above embodiment has been described with reference to the configuration in which the first protrusion 513 and the second protrusion 524 include edges of the respective substrates, but the invention is not limited to the configuration described above. For example, a through hole passing through the second substrate 52 along the thickness direction thereof may be formed in the position facing the first electrode pad 541B on the first substrate 51. Similarly, a through hole passing through the first substrate 51 along the thickness direction thereof may be formed in the position facing the second electrode pad 542B on the second substrate 52.

Further, in the embodiment described above, the direction in which the first substrate 51 is offset relative to the second substrate 52 is the direction from the first side 51A toward the second side 51B, but the offset direction is not limited thereto. The offset may be carried out in any direction that allows a region where the first substrate 51 and the second substrate 52 do not overlap with each other to be created. In this case, the first electrode pad or the second electrode pad is provided in the region where the first substrate 51 and the second substrate 52 do not overlap with each other.

Further, in the manufacturing steps in the embodiment described above, the first thin piece 50C is formed in the position on the first substrate 51 that faces the second protrusion 524 of the second substrate 52, and the first thin piece 50C is removed after the bonding step. Similarly, the second thin piece 60C is formed in the position on the second substrate 52 that faces the first protrusion 513 of the first substrate 51, and the second thin piece 60C is removed after the bonding step. The etalon 5 according to the embodiment of the invention is not necessarily manufactured this way. For example, the first substrate 51 with no first thin piece 50C described in the above embodiment is manufactured in advance, and the second substrate 52 with no second thin piece 60C described in the above embodiment is manufactured in advance. The first substrate 51 and the second substrate 52 are then offset relative to each other and bonded to each other. This alternative method eliminates the need to form and remove the first thin piece 50C and the second thin piece 60C, whereby the manufacturing efficiency is improved.

Further, in the embodiment described above, the bonding surfaces 514 and 525 are bonded to each other via the first bonding film 581 and the second bonding film 582. Alternatively, for example, no first bonding film 581 and second bonding film 582 may be formed. In this case, the bonding surfaces 514 and 525 may be bonded to each other by using any other suitable bonding method, for example, what is called room-temperature surface activated bonding in which the bonding surfaces 514 and 525 are activated, overlaid on each other, pressurized, and bonded to each other.

Further, the connection between the etalon 5 and the voltage controller 6 has been described with reference to the case where a flexible substrate is connected to the first electrode pad 541B and the second electrode pad 542B, but the connection is not necessarily made this way. For example, conductive wires may be connected to the first electrode pad 541B and the second electrode pad 542B in a wire bonding process. Since the formation of the first protrusion 513 and the second protrusion 524 allows working spaces for wiring to be provided, wiring can be efficiently performed in any wiring method.

In addition to the above, the specific structures for and procedures of implementing the invention can be changed as appropriate as long as other structures and procedures can achieve the advantage of the invention.

What is claimed is:

1. A method for manufacturing an optical filter having a first substrate and a second substrate facing the first substrate, the method comprising the steps of:
(a) forming a first reflection film, a first electrode and a first electrode pad on the first substrate;
(b) forming a second reflection film, a second electrode and a second electrode pad on the second substrate, the second reflection film facing the first reflection film, and the second electrode facing the first electrode;
(c) bonding the first substrate and the second substrate together;
(d) after (c), removing a first facing part of the first substrate facing at least part of the second electrode pad; and
(e) after (c), removing a second facing part of the second substrate facing at least part of the first electrode pad.

2. The method according to claim 1, further comprising:
forming the first facing part such that a thickness of the first facing part is thinner than a bonding part of the first substrate in (c); and
forming the second facing part such that a thickness of the second facing part is thinner than a bonding part of the second substrate in (c).
